(19) United States
(12) Patent Application Publication
(10) Pub. No.: US 2006/0252004 A1
(43) Pub. Date: Nov. 9, 2006

(54) Camera system

(76) Inventor: Randall W. Donahoo, Newcastle, OK (US)

Correspondence Address: DUNLAP, CODDING & ROGERS P.C., PO BOX 16370, OKLAHOMA CITY, OK, 73113, US

(21) Appl. No.: 11/416,726

(22) Filed: May 3, 2006

Related U.S. Application Data
(60) Provisional application No. 60/677,321, filed on May 3, 2005.

(51) Int. Cl. A61C 1/00

(52) U.S. Cl. 433/29

(57) ABSTRACT

A camera system for performing a procedure, such as a dental procedure, including a camera having an image sensor positioned therein and a lens connected to the camera. The lens is spaced from the image sensor to permit a magnified image of an object to be captured by the image sensor when the lens is positioned at least about five inches from the object with a depth of field at least about 3.5 inches. A monitor is connected to the camera to view the magnified image of the object captured by the image sensor.

### CROSS REFERENCE TO RELATED APPLICATIONS

This application claims benefit of U.S. Provisional Application No. 60/677,321, filed May 3, 2005, which is incorporated herein by reference in its entirety.

### BACKGROUND OF THE INVENTION

1. Field of the Invention

The present invention relates generally to a camera system, and more particularly, but not by way of limitation, to an improved extra-oral camera system and methods of using same.

2. Brief Description of Related Art

Today's dental procedures are labor intensive thereby requiring dentists to make adjustments to their daily practices. For example, procedures such as cosmetic dentistry, root canals, perio surgery and implant dentistry require a dentist to spend lengthy periods of time looking inside a patient's mouth while performing dental examinations and procedures. Furthermore, today's dental techniques require dentists to frequently twist and turn while reaching for numerous dental instruments as well as requiring dentists to look within a patient's mouth for extended periods of time (i.e., two to three hours) without movement. It is well known that dentists must position their upper torsos in a hunched or bent position over the patient's mouth to properly position and utilize their instruments and eyes to perform such procedures.

It has been reported that at least 40 to 60 percent of dentists suffer from neck, back, and shoulder pain resulting from the movements and positions described above that a dentist must maintain to perform dental procedures. As a result, many dentists must rely on weekly therapeutic or chiropractic treatment to alleviate or minimize pain resulting from the required positioning of their upper torsos. Due to the fact that many dentists can only work up to three days per week because of the bodily pain associated with the body positioning demanded by their practice, many dentists must seek early retirement.

In the last few years, many dentists have started using dental loops or magnifying glasses to prevent bending or hunching their uppertorsos while performing oral procedures. Such devices have enhanced a dentist's view of the mouth yet have added excess weight to their face/nose area creating added strain on the neck, back, and shoulder area. Furthermore, because of the proximity of the lenses to the patient's mouth, the lenses often become clouded with water spray.

Intra-oral and extra-oral cameras have also been suggested for use in dental practices. However, such cameras are limited in their use. Intra-oral cameras are designed to be positioned in the patient's mouth to take an image for the purpose of documenting cases, simulating treatment results, communicating more easily with labs, and to correspond with fellow colleagues. Intra-oral cameras are not designed to be used to allow a dentist to perform a procedure while monitoring the work area on a monitor. In contrast, it has been suggested to use an extra-oral camera to project an image of the patient's mouth on a monitor to allow the dentist to perform a dental procedure while viewing the monitor, thereby allowing the dentist to remain in a more ergonomic position. However, to this point, a camera has not been available that provides a clear, magnified image of the entire patient's mouth. That is, cameras that provide sufficient magnification suffer from a shallow depth of field, while cameras that provide a suitable depth of field suffer from a lack of magnification. As such, to maintain a clear image of a work area requires the dentist to continually make adjustments to the focus of the camera which is a cumbersome task, particularly when the dentist is in the middle of a procedure.

To this end, a need exists for a camera system that allows the dentist to work on a patient's teeth while maintaining an ergonomically correct posture and which provides a clear, magnified image of the patient's mouth. It is to such a system that the present invention is directed.

### BRIEF DESCRIPTION OF THE SEVERAL VIEWS OF THE DRAWINGS

FIG. 1 is a perspective view of a camera system constructed in accordance with the present invention.

FIG. 2 is an enlarged perspective view of a camera and a lens.

FIG. 3 is a schematic view of the camera and lens.

FIG. 4 is a perspective view of another embodiment of a camera system constructed in accordance with the present invention.

FIG. 5 is a perspective view of another embodiment of a camera system constructed in accordance with the present invention.

FIG. 6 is a perspective view of another embodiment of a camera system constructed in accordance with the present invention.

FIG. 7 is a perspective view of another embodiment of a camera system constructed in accordance with the present invention.

### DETAILED DESCRIPTION OF THE INVENTION

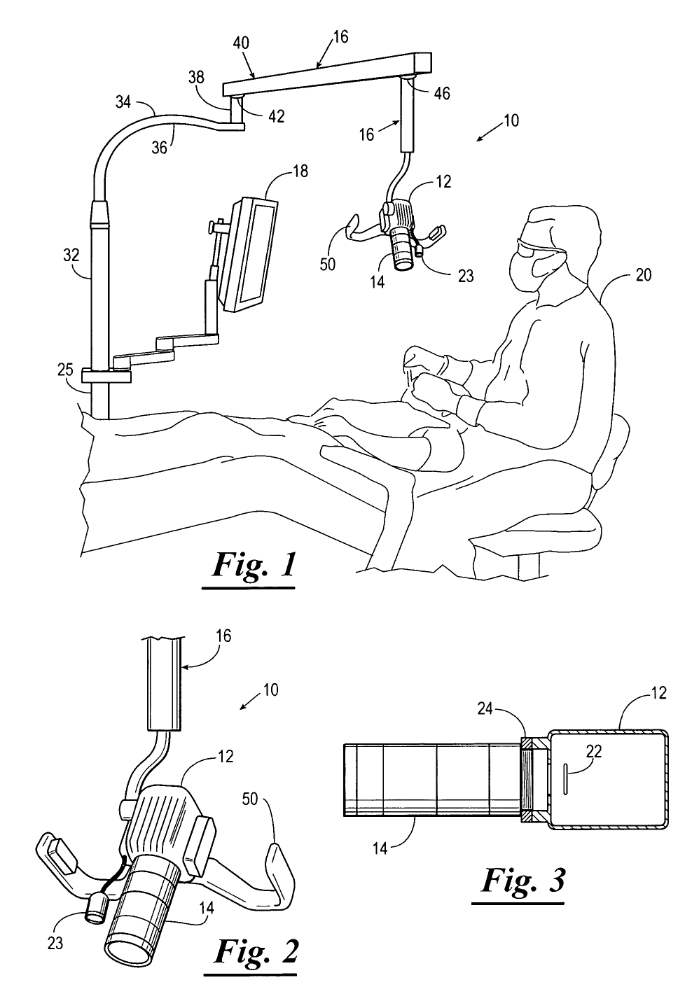

Referring now to the drawings, and more particularly to FIGS. 1 and 2, a camera system 10 constructed in accordance with the present invention is illustrated. Broadly, the camera system 10 includes a camera 12, a lens 14, an articulating support arm assembly 16, and a monitor 18. The camera system 10 enables a dentist 20 to work on a patient's teeth while viewing the monitor 18 thereby permitting the dentist 20 to maintain an ergonomically correct posture. Moreover, the camera system 10 provides a clear, magnified image of the patient's mouth with a depth of field that extends over the entire mouth of the patient. More specifically, the camera system 10 allows magnification up to about 22× with a depth of field of from about 3.5 inches to about 4.5 inches and the lens 14 positioned from the patient's mouth a distance of from about five inches to about twenty inches. As such, the patient's entire mouth may remain in focus eliminating the need to continuously refocus the camera system 10. Also, the camera system 10 is maintained at a distance from the patient so that it remains out of the way of the dentist 20 performing a procedure and the lens 14 is not susceptible to becoming fogged or clouded by a patient's breath or spray from dental instruments.

In the preferred embodiment, the camera 12 is a miniature digital color CCD camera that includes an image sensor 22 (FIG. 3), a full control on-screen menu, flicker control, and the ability to control shutter speed. An example of a suitable camera is Model No. S1-C400N available from Costar Group Company, Ltd. of South Korea which has been modified to cause the lens 14 to be positioned approximately 5 mm closer to the image sensor 22 than intended by an original camera to modify the focal length or so that the distance between the optics of the lens 14 and the CCD is about 12.52 mm. This modification is achieved by reducing the length of a ring adapter 24. In the preferred embodiment, the image sensor 22 is a ½ inch CCD. However, it should be appreciated that ⅓ inch and ¼ inch CCDs can be used. Also, the camera 12 may be provided with a three chip CCD allowing for more precise color separation for cancer screening and pathology review.

In the preferred embodiment, the lens 14 is a macro zoom lens. An example of a suitable lens is Model No. MLH-10X, available from Computar. Such a lens is provided with aperture, zoom, and focus ability that enables the use of ambient light only. As such, external light sources are not required. However, an external light source 23 may be used. An example of a suitable light source is a medical grade, non-UV, cool white LED light. The light source 23 has an adjustable beam spread ideal for working on a single tooth or an entire arch.

To compensate for the modification to the focal length, the lens 14 is set to manual, the camera 12 is preferably set as follows: AGC—32 dp, shutter— 1/60, white balance at 5600 k to match the 5500 k LED, back light—on, gamma—14 level 0.45, color at phase—04 (level—04), sharpness—low, contrast—off, brightness—level 05, flickerless—on.

Spacers may be used between the lens 14 and the camera 12 to cause the focal length to be changed so that the combination of the camera 12 and the lens 14 may be customized depending on the type of dentistry being conducted. For example, no spacer may be required if the dentist is conducting general dentistry. However, a five millimeter spacer may be used for endodontic procedures, and a ten millimeter spacer used for periodontic procedures.

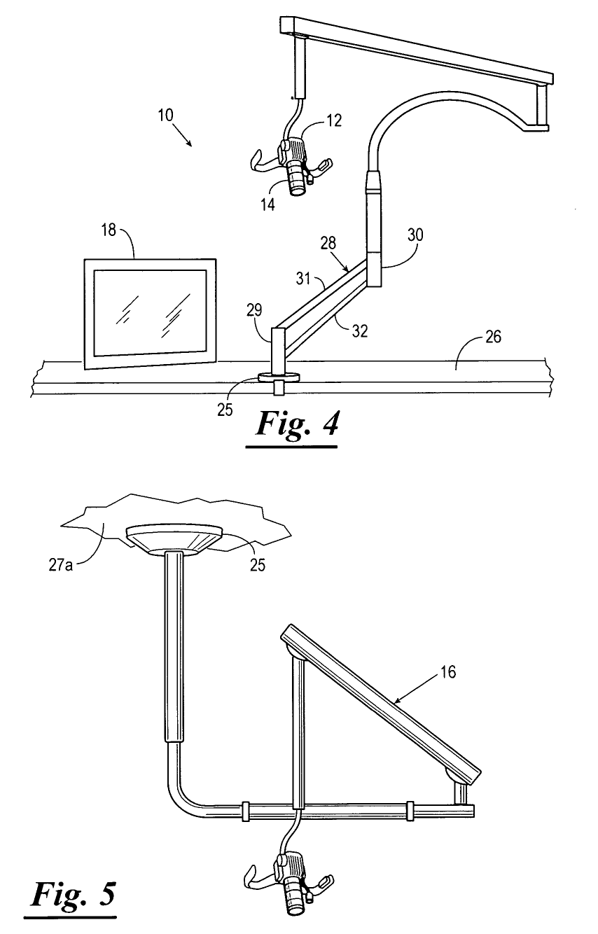

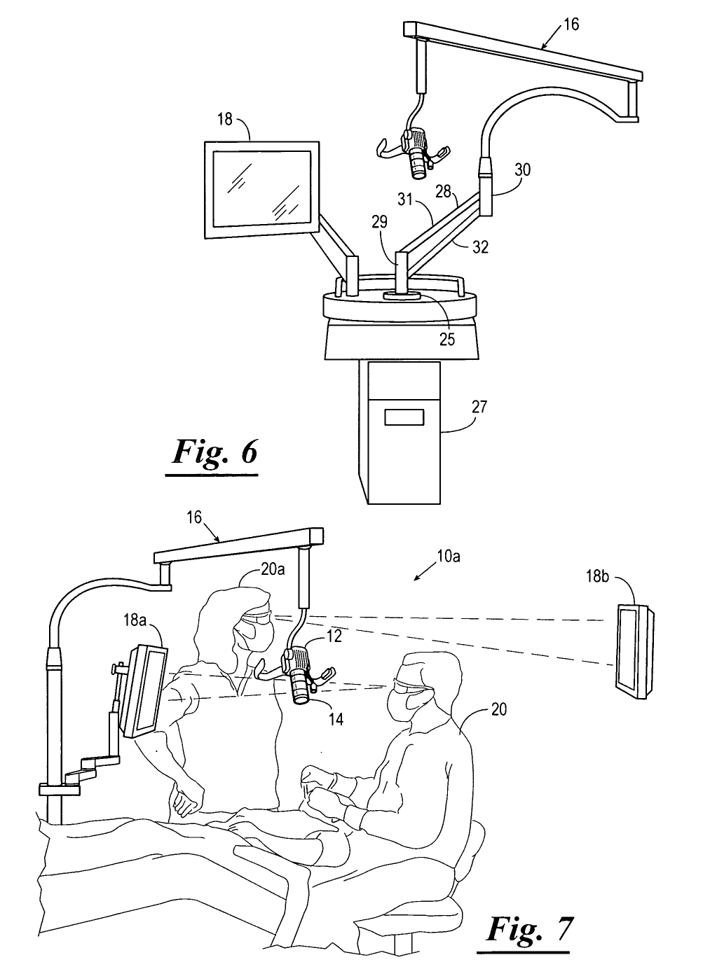

The support arm assembly 16 is adapted to support the combination of the camera 12 and the lens 14 above the mouth of a patient when in use and also allows the combination of the camera 12 and lens 14 to be stored out of the way in a relatively compact space. The support arm assembly 16 includes a base 25 that is adapted to be secured to a support surface such as the floor (FIG. 1) or a wall, cabinet, counter top 26 (FIG. 4), track, ceiling 26a (FIG. 5), or other support structure, such as a mobile cart 27 (FIG. 6). The monitor 18 may be supported on similar support surfaces.

A vertical extension member 33 is connected to the second support bracket 26. In a preferred embodiment, the vertical extension member 33 is approximately twelve inches in length, but the length may be varied.

A swivel arm 34 is connected to the upper end of the vertical extension member 33. The swivel arm 34 includes an arcuate portion 36 and a vertical portion 38. The arcuate portion 36 is rotatably connected to the upper end of the vertical extension member 33. The distal end of the vertical portion 38 is rotatably connected to a boom arm assembly 40. In a preferred embodiment, the arcuate portion 36 has a length of about 25 inches and a width of about ten inches. The vertical portion 38 has a length of about four inches.

The boom arm assembly 40 includes a first spring housing 42, an arm 44, and a second spring housing 46. The first spring housing 42 is pivotally connected to one end of the arm 44 and the second spring housing 46 is pivotally connected near the other end of the arm 44. In a preferred embodiment, the arm 44 has a length of approximately 30 inches, but the length of the arm 44 may vary widely.

The first and second spring housings 42 and 46 enclose coil springs (not shown) which support the arm 44 in a desired position. The second spring housing 46 is rotatably connected to a yoke 50. The yoke 50 is adapted to support the camera 12.

The FIGS. 4 and 6 include a rocker arm assembly 28 pivotally connected to the base 25. The rocker arm assembly 28 includes a first support bracket 29, a second support bracket 30, and an arm 31. One end of the arm 31 is pivotally connected to the first support bracket 29 and an opposing end of the arm 31 is pivotally connected to the second support bracket 30. The first support bracket 29 is rotatably mounted to the base 25 to permit 360 degrees of rotation. The rocker arm assembly 28 further includes an actuator 32 extending between the first support bracket 29 and the second support bracket 30 so as to permit the second support bracket 30 to be moved in an up and down motion relative to the first support bracket 29 in a controlled manner. In a preferred embodiment, the arm 31 has a length of about sixteen inches.

The support arm assembly 16 allows the camera 12 to be moved up and down and side to side to permit the camera 12 to be positioned at a desired position relative to a patient's mouth. The construction of the support arm assembly 16 allows the camera 12 to be positioned anywhere from approximately 26 inches from the floor to about 90 inches off the floor, reach approximately 72 inches across a room, and be stored in an approximately 36 inch wide space. The springs 48 and actuators 32 are adjusted to eliminate drift and create easy movement of the support arm assembly 16.

Cables (not shown) extending between the camera 12 and the monitor 18 and a power supply (not shown) are run through the support arm assembly 16. It should also be appreciated the camera 12 and the monitor 18 may communicate without the use of cables through wireless technology. For example, using radio frequency or infrared waves to communicate data between the devices.

The camera 12 further includes a picture capture device to freeze frame images on the monitor 18. In one embodiment, the picture capture device uses a foot pedal control to allow a user to capture images and either view full size single images or quad-format screens with four images at once. The camera system 10 may communicate the captured pictures or real-time video to a recording device such as a VCR, DVD recorder, or saved into a computer system. For example, images may be archived for procedures for liability purposes, patient communication, or as a teaching and training tool. The camera system 10 further includes a printer to print such pictures. The picture capture device further includes a mirror image switch so that a dentist can get either a direct view or a mirror image view on the monitor 18.

The camera system 10 is also adapted to be used in combination with an intra-oral camera so that a dentist can get an angle view of what he is working on when using a hand drill which is typically positioned over the teeth and blocking the view of the camera 12. Use of an intra-oral camera allows one to set the camera at an angle so the dentist can see on the screen and not have to use a mirror.

The camera system 10 further utilizes filters made for dental, medical, or industrial lasers which can create sparks each time the laser is fired. The filters will take out the spark on the monitor 18. The filters are positioned at the end of the lens 14. Additionally, a variety of diopters may be used on the end of the lens 14 to provide different focal lengths and depths of field.

In use, the camera 12 and the lens 14 are positioned to view the mouth of a patient. The unique combination of the camera 12 and lens 14 allows the lens 14 to be positioned a distance of approximately five to twenty-four inches from the patient's mouth thereby not interfering with the work of the dentist. The monitor 18 is positioned for ease of viewing by the dentist. The camera 12 is focused on the tooth or teeth to be worked on. Once the work area is set up, the dentist can view the work area on the monitor instead of bent over in the mouth.

FIG. 7 illustrates another embodiment of a camera system 10a which is substantially similar to the camera system 10 described above, except the camera system 10a includes a first monitor 18a and a second monitor 18b. The first monitor 18a is positioned to be viewed by the dentist 20 while the second monitor 18b is positioned to be viewed by an assistant 20a. As a result, the assistant 20a may view what the dentist 20 is viewing and maintain an ergonomic position.

It should also appreciated that the camera system 10 of the present invention may also be used for medical procedures, veterinarian procedures, quality control of machining processes, and other processes that benefit from working in a magnified environment.

From the above description, it is clear that the present invention is well adapted to carry out the objects and to attain the advantages mentioned herein, as well as those inherent in the invention. While a presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A camera system, comprising:
an articulating arm assembly connectable to a support surface;
a camera connected to the articulating arm, the camera having an image sensor positioned therein;
a lens connected to the camera, the lens spaced from the image sensor to permit a magnified image of an object to be captured by the image sensor when the lens is positioned at least about five inches from the object with a depth of field at least about 3.5 inches; and
a monitor connected to the camera to view the magnified image of the object captured by the image sensor.

2. The camera system of claim 1, further comprising a plurality of monitors connected to the camera to view an image captured by the camera.

3. The camera system of claim 1, further comprising a light source connected to the camera.

4. The camera system of claim 1, wherein the articulating arm is connected to a ceiling.

5. The camera system of claim 1, wherein the articulating arm is connected to a portable cart.

6. The camera system of claim 1, wherein the lens is adjustable relative to the image sensor to change the magnification of the image of the object from about 2× to about 22× with the depth of field remaining at least about 3.5 inches.

7. A dental camera system, comprising:
an articulating arm assembly connected to a support surface;
a camera connected to the articulating arm, the camera having an image sensor positioned therein;
a lens connected to the camera, the lens being spaced from a patient's mouth at least about five inches; and
a monitor connected to the camera to view an image captured by the camera, the image being magnified and having a depth of field of at least about 3.5 inches.

8. The dental camera system of claim 7, further comprising a plurality of monitors connected to the camera to view an image captured by the camera, each monitored positioned to be viewed by a person positioned on either side of the patient.

9. The dental camera system of claim 7, further comprising a light source connected to the camera.

10. The dental camera system of claim 7, wherein the articulating arm is connected to a ceiling.

11. The dental camera system of claim 7, wherein the articulating arm is connected to a portable cart.

12. The camera system of claim 7, wherein the lens is adjustable relative to the image sensor to change the magnification of the image of the object from about 2× to about 22× with the depth of field remaining at least about 3.5 inches.

13. A method of preparing to perform a dental procedure, comprising:
connecting a camera to an articulating arm, the camera having an image sensor positioned therein;
attaching a lens to the camera so that the lens is spaced from the image sensor to permit a magnified image of the interior of a patient's mouth with a depth of field of at least about 3.5 inches to be captured by the image sensor when the lens is positioned at least five inches from the object;
connecting the camera to a monitor;
positioning the monitor so that the monitor is viewable by a dentist while performing a procedure on a patient's mouth;
spacing the lens from the patient's mouth a distance of at least about five inches;
directing the lens at the patient's mouth to capture an image of the interior of the patient's mouth on the monitor; and
adjusting the position of the lens relative to the image sensor so that the interior of the patient's mouth is magnified and substantially all the interior of the patient's mouth is in focus.

14. The method of claim 13, further comprising the steps of:
connecting the camera to a second monitor; and
positioning the second monitor so that the monitor is viewable by another person positioned adjacent the patient and substantially opposite the dentist.

15. The method of claim 13, further comprising the step of adjusting the position of the lens relative to the image sensor so that the interior of the patient's mouth is magnified in a range of from about 2× to at least about 22× with the depth of field remaining at least about 3.5 inches.

16. The method of claim 13, further comprising the step of capturing a freeze frame image on the monitor.

17. A method of preparing to perform a procedure, comprising:
connecting a camera to an articulating arm, the camera having an image sensor positioned therein;
attaching a lens to the camera so that the lens is spaced from the image sensor to permit a magnified image of an object having a depth of field of at least about 3.5 inches to be captured by the image sensor when the lens is positioned at least five inches from the object;
connecting the camera to a monitor;
positioning the monitor so that the monitor is viewable by a person to perform the procedure while the person is performing the procedure;
spacing the lens from the object a distance of at least about five inches;
directing the lens at the object to capture an image of the object on the monitor; and
adjusting the position of the lens relative to the image sensor so that the object is magnified and substantially all object is in focus.

18. The method of claim 17, further comprising the steps of:
connecting the camera to a second monitor; and
positioning the second monitor so that the monitor is viewable by another person positioned adjacent the object and substantially opposite the person performing the procedure.

19. The method of claim 17, further comprising the step of capturing a freeze frame image on the monitor.
